(19) United States
(12) Patent Application Publication
(10) Pub. No.: US 2020/0056434 A1
(43) Pub. Date: Feb. 20, 2020

(54) PNEUMATIC CONVEYING UNIT, METHOD AND SYSTEM FOR CONVEYING DRILL CUTTINGS IN ONSHORE DRILLING RIGS

(71) Applicants: Guillermo Eugenio Fantini, Sao Paulo (BR); Marcelo Guimarães Osório, Sao Paulo (BR); Yuri Andrade de Araujo, Sao Paulo (BR)

(72) Inventors: Guillermo Eugenio Fantini, Sao Paulo (BR); Marcelo Guimarães Osório, Sao Paulo (BR); Yuri Andrade de Araujo, Sao Paulo (BR)

(21) Appl. No.: 16/220,390

(22) Filed: Dec. 14, 2018

(30) Foreign Application Priority Data
Aug. 17, 2018 (AR) P20180102367

(51) Int. Cl. E21B 21/06; B65G 53/04; E21B 21/01; E21B 41/00

(52) U.S. Cl. CPC E21B 21/066; B65G 53/04; E21B 2021/007; E21B 41/005; E21B 21/01

(57) ABSTRACT

The invention pertains to the pneumatic conveyance of drill cuttings in onshore drilling rigs, where drill cuttings are conveyed by a pneumatic conveying unit arranged on a mobile platform.

### FIELD OF INVENTION

This invention pertains to well drilling operations in the oil and gas industry. In particular, this invention pertains to a method, a system and a mobile unit for transporting drill cuttings from onshore well drilling operations.

### BACKGROUND OF THE INVENTION

Drilling is an oil industry activity used to locate underground. reservoirs and to extract oil or gas from these reservoirs. Basically, a drill bit is driven down by a drilling rig in order to form wells. Use of drilling fluids is of the utmost importance in well drilling operations. Among other purposes, drilling fluids help maintain reservoir pressures under control, remove waste produced by drilling (known as drill cuttings) to the surface and cool the drill bit. Wells may be located on land (onshore) or at sea (offshore).

Drill cuttings are a combination of debris produced and the fluids used for drilling. Storage and disposal of these cuttings are of particular importance in drilling rigs, since they cannot simply be discarded, due to environmental concerns.

As is common practice in the industry, drill cuttings that reach the surface are processed by solid control equipment. The goal is to separate as much of the fluids from the solids as possible. In onshore operations, the resulting drill cuttings are basically placed in waste bins, such as dumpsters, which are subsequently hoisted onto roll-off trucks that transport them to another location for processing and/or disposal. Alternatively, a large hole is dug and lined with canvas. Then a machine, for example, a backhoe, removes the drill cuttings from tanks and places them in the hole, where they remain until they may be transported by truck.

Current methods for collection, storage and transportation of drill cuttings are clearly inefficient and unsafe, as well as being subject to environmental accidents. Furthermore, they require dedicated equipment (e.g. cranes) and personnel at the drilling rig, which can end up increasing production costs.

### SUMMARY OF THE INVENTION

The purpose of this invention is to improve the collection, storage and transportation of drill cuttings in onshore operations.

Other goals and benefits of this invention are provided in the description below.

This invention pertains to a pneumatic conveying unit for conveying drill cuttings in onshore drilling rigs, comprising at least one pressure vessel and at least one compressor to pressurize the at least one pressure vessel, wherein the pneumatic conveying unit is part of a mobile platform.

Optionally, the pneumatic conveying unit may also comprise at least one collector for receiving drill cuttings and for directing cuttings received into the at least one pressure vessel.

Optionally, the at least one collector has an open top and is positioned directly above the at least one pressure vessel.

Optionally, the mobile platform of the pneumatic conveying unit may also be moved vertically.

This invention also pertains to a discharge unit for discharging drill cuttings from onshore drilling rigs, comprising at least one receiver, at least one pipe and at least one outlet, wherein the receiver is configured to direct the received drill cuttings to the at least one outlet via the at least one pipe, and wherein the discharge unit is part of a mobile platform.

Optionally, the at least one receiver is a valve.

The invention also pertains to a method for conveying drill cuttings in onshore drilling rigs, comprising the steps of: receiving drill cuttings in a pneumatic conveying unit; and pneumatically conveying the drill cuttings to at least one dumpster, wherein the pneumatic conveying unit is as defined above.

Optionally, the method additionally includes the step of processing drill cuttings using at least one solid control device, before they reach the pneumatic conveying unit.

Optionally, the method additionally includes the step of storing the drill cuttings in at least one tank, before they reach the pneumatic conveying unit.

Optionally, the at least one dumpster is part of a mobile platform, the method additionally comprising the step of transporting the dumpster to a drill cutting discharge area.

Optionally, the method additionally comprises the step of conveying the drill cuttings to the at least one dumpster by means of at least one receiver.

Optionally, the at least one receiver is arranged on a mobile structure.

The invention also pertains to a system for conveying drill cuttings in onshore drilling rigs, comprising: a pneumatic conveying unit to receive drill cuttings from the drilling rig; and at least one dumpster to receive the drill cuttings from the pneumatic conveying unit, wherein the pneumatic conveying unit is as defined above.

Optionally, the system additionally comprises at least one solid control device to receive the drill cuttings before they are sent to the pneumatic conveying unit.

Optionally, the at least one dumpster is part of a mobile platform.

Optionally, the system comprises at least one receiver for directing the drill cuttings to the at least one dumpster.

Optionally, the at least one receiver is arranged on a mobile structure.

### BRIEF DESCRIPTION OF THE DRAWINGS

FIG. 1 depicts a general schematic overview of the transportation and storage of drill cuttings, according to this invention.

FIG. 2 depicts a view of the mobile pneumatic conveying unit, according to this invention.

FIG. 3 depicts a frontal view of the mobile discharging unit according to a preferred embodiment of this invention.

FIG. 4 depicts a perspective view of the mobile discharging unit according to a preferred embodiment of this invention.

### DETAILED DESCRIPTION OF THE INVENTION

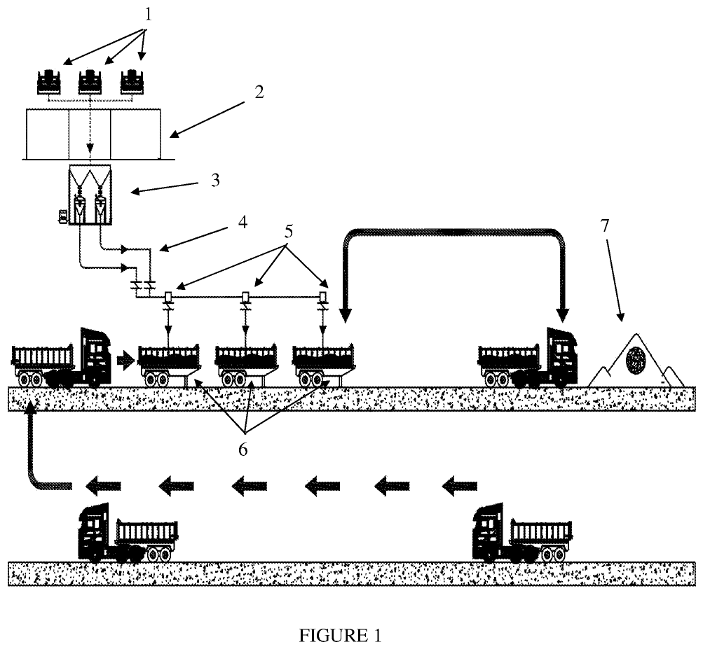

As explained above, drill cuttings is carried to the surface where it is usually processed using a solid control device, in order to separate liquid (drilling fluid) from solids (debris). In the embodiment illustrated by FIG. 1, at least one shale shaker 1 is optionally used. As shall be appraised by a technician skilled in the art, other solid control devices, such as vertical centrifuges and horizontal centrifuges, may also be used in conjunction with a shale shaker. Also in the embodiment illustrated by FIG. 1, the cuttings coming out of the shale shaker may be conveyed to at least one tank 2. Depending on the drilling operation, it is possible that no solid control equipment is used; in this case, drill cuttings are discharged directly into tanks.

Subsequently, the drill cuttings are carried to at least one pneumatic conveying unit 3. As may be observed, the presence of the tanks 2 is optional, and drill cuttings coming out of the wells may be conveyed directly to a pneumatic conveying unit. 3. The principles of the pneumatic conveyance of materials are already described in full in the state of the art and do not need to be described here in detail. Basically, the material to be transported is placed inside a pressure vessel. After filling the pressure vessel, air is used to force this material through a pipe that takes this material to the intended destination. Similarly, there are several methods in the state of the art that may be used to carry the drill cuttings to the pneumatic conveying unit 3. For example, conveyors, pumps and chutes equipped with helical screws.

The pneumatic conveying unit 3, according to this invention, is illustrated by FIG. 2. As may be observed, a collector 31 is placed above two pressure vessels 32. Optionally, the collector has an open top to receive the drill cuttings that fall into it and holes in the lower section to convey the waste received into the pressure vessels 32. Although two pressure vessels are illustrated, one or more pressure vessels may be used. Similarly, although one collector is illustrated supplying the pressure vessels, each pressure vessel could be associated with an individual collector. Further, in an alternative embodiment, it is possible not to have any collectors, wherein the drill cuttings would be transported into the pressure vessels 32 by means of hoses or pipes. At least one compressor 33 is also envisaged to provide pressurized air inside the pressure vessels 32. The collector 31, pressure vessels 32 and compressor 33 are arranged on a mobile platform. This mobile platform, as illustrated, may be towed by a truck or similar vehicle. Alternatively, the mobile platform may be an integrated part of the truck (or similar vehicle) itself.

Returning to FIG. 1, drill cuttings leave the pneumatic conveying unit 3 via pipes 4 and are transported to receivers 5, from where they are discharged into dumpsters 6. The receivers 5 are essentially valves that direct waste either to the dumpster outlet or to the continuation of the pipe 4. An example of a valve that may be used is the posi-flate® inflatable seated butterfly valve, marketed by Dynamic Air Ltda. As may be observed, one or more dumpsters may be used. In situations where only one dumpster is used, there is no need for any receiver 5. As illustrated by FIG. 1, dumpsters are optionally mobile platforms that may be towed by a truck or similar vehicle. Alternatively, dumpsters may be an integrated part of the truck (or similar vehicle) itself. Trucks take the cuttings stored in dumpsters to a discharge area 7, or to a facility far additional processing.

Use of more than one dumpster and more than one receiver 5 is particularly beneficial, considering that, as one dumpster is filled, a receiver 5 conveys cuttings to the next dumpster. Accordingly, drill cuttings may be stored and transported without suspending operation of the drilling rig. Use of dumpsters as mobile platforms is even more beneficial, as a single truck (or similar vehicle) could be used to transport the cuttings, as illustrated by FIG. 1. In this setup, while a truck takes a dumpster to the discharge area 6 and returns to the drilling rig, other dumpsters are filled, and the same cycle starts over.

Because it is mobile, the pneumatic conveying unit 3 of this invention has additional benefits. Because it is pre-assembled, there is no need to install individual items of equipment (collector, pressure vessels and compressor) at the drilling rig. It only needs to be positioned in the correct place to receive the drill cuttings. This greatly reduces operation start-up times. In addition to logistical gains, this reduction is particularly important for onshore drilling operations that last a few days with a high rate of DTM (demobilization, transport and mobilization), thus precluding long installation and disassembly times, as well as long time far transportation of equipment. Additionally, a single mobile pneumatic conveying unit may serve more than one drilling rig, as required. There is no obligation to have fixed pneumatic conveying equipment installed at each drilling rig, which could render operations more complex and costlier. Accordingly, the use of one or more tanks 2 may be particularly beneficial, since the tanks in this scenario are filled with cuttings until a mobile pneumatic conveying unit reaches the drilling rig and can remove the cuttings stored in the tanks.

The mobile pneumatic conveying unit of the invention, in the preferred embodiment where one or more open top collectors are positioned directly above one or more pressure vessels, is particularly beneficial because it precludes the necessity for any elements (such as conveyors, hoses, chutes or pipes) for carrying cuttings to pressure vessels. In this embodiment, the unit only needs to be positioned below the outlet for drill cuttings (shale shakers, for example), which fall into the collector. This further reduces installation time and renders drill cutting transportation even more efficient. Depending on the design of the drilling rig, there may be a short distance between the ground and the drill-cutting outlet. Thus, there may be an issue pertaining to sufficient height for positioning the pneumatic conveying unit below the aforementioned cutting outlet. In a preferred embodiment, the mobile platform of the pneumatic transportation unit 3 of this invention may be moved vertically. As any technician in the art may observe, several state-of-the-art methods may be used, for example use of hydraulic or pneumatic actuators. In addition to assisting the positioning of the pneumatic conveying unit below the cuttings outlet, lowering the platform of the unit until it rests on the ground also assists in securing the unit in a fixed position during operation.

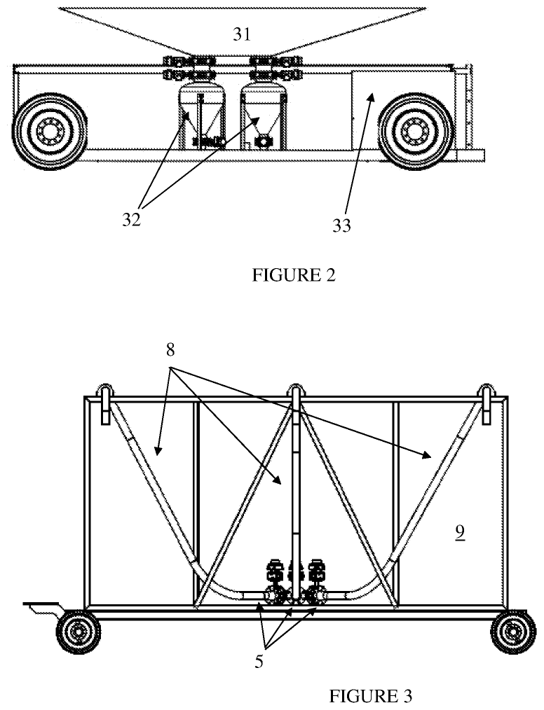

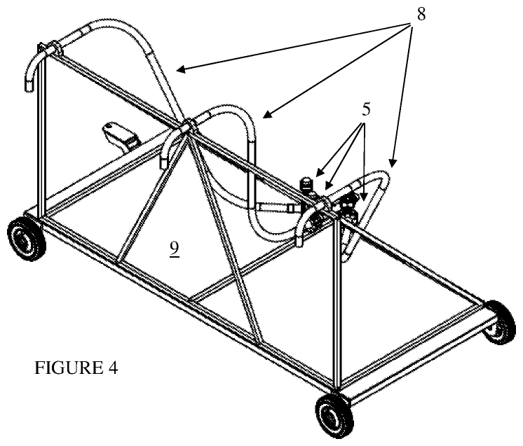

The receivers 5, as illustrated in FIGS. 3 and 4, may be arranged on a mobile structure forming a mobile cuttings discharge unit 9. In a similar fashion to the mobile pneumatic conveying unit, the arrangement of the receivers 5 on a mobile structure simplifies the installation process, further reducing the time required far this process. With the receivers 5 pre-assembled on the mobile structure, the structure then only needs to be positioned at the site where the drill cuttings are discharged into the dumpsters. Then, the pipe 4 is installed between the pneumatic conveying unit 3 and discharge unit 9—more specifically, between the lower outlet of the pressure vessels and receivers. The discharge unit 9, as illustrated, has pipes 8 that convey drill cuttings arriving at the discharge unit to outlets, from where they fall into dumpsters.

In the preferred embodiment of this invention, the pneumatic conveying unit 3 is used in conjunction with the mobile discharge unit 9 and more than one dumpster 6 on mobile platforms. This combination greatly reduces the complexity and consequently the installation time of the entire system for the transportation and storage of drill cuttings. Additionally, a single truck can be used to position the mobile pneumatic conveying unit and to transport the dumpsters to the disposal area.

1. A pneumatic conveying unit configured to convey drill cuttings on onshore drilling rigs, comprising:
at least one pressure vessel, and
at least one compressor configured for pressurization of the at least one pressure vessel,
wherein the pneumatic conveying unit is part of a mobile platform.

2. The pneumatic conveying unit according to claim 1, further comprising at least one collector configured to receive the drill cuttings and further configured to carry the cuttings received to the inside of the at least one pressure vessel.

3. The pneumatic conveying unit according to claim 1, wherein the at least one collector has an open upper part and is positioned directly above at the least one pressure vessel.

4. The pneumatic conveying unit according to claim 1, wherein the mobile platform may also be moved vertically.

5. A discharge unit for discharging drill cuttings from onshore drilling rigs, comprising:
at least one receiver,
at least one pipe, and
at least one outlet,
wherein the receiver is configured to direct the received drill cuttings to the at least one outlet via the at least one pipe, and wherein the discharge unit is part of a mobile platform.

6. The discharge unit according to claim 5, wherein the at least one receiver is a valve.

7. A method for conveying drill cuttings in onshore drilling rigs, comprising the steps of:
receiving drill cuttings in a pneumatic conveying unit; and
pneumatically conveying the drill cuttings to at least one dumpster;
wherein the pneumatic conveying unit comprises:
at least one pressure vessel, and
at least one compressor configured for pressurization of the at least one pressure vessel, and
wherein the pneumatic conveying unit is part of a mobile platform.

8. The method according to claim 7, further comprising the step of processing the drill cuttings using at least one solid control device before these cuttings reach the pneumatic conveying unit.

9. The method according to claim 7, further comprising the step of storing the drill cuttings in at least one tank before these cuttings reach the pneumatic conveying unit.

10. The method according to claim 7, wherein the at least one dumpster is part of a mobile platform, the method further comprising the step of transporting the dumpster to a drill cuttings discharge area.

11. The method according to claim 7, further comprising the step of conveying drill cuttings to the at least one dumpster by means of at least one receiver.

12. The method according to claim 11, wherein the at least one receiver is part of a discharge unit, said discharge unit comprising:
at least one receiver,
at least one pipe, and
at least one outlet,
wherein the receiver is configured to direct the received drill cuttings to the at least one outlet via the at least one pipe, and wherein the discharge unit is part of a mobile platform.

13. A system far conveying drill cuttings in onshore drilling rigs, comprising:
a pneumatic conveying unit to receive drill cuttings from the drilling rig; and
at least one dumpster to receive drill cuttings from the pneumatic conveying unit;
wherein the pneumatic conveying unit comprises:
at least one pressure vessel, and
at least one compressor configured for pressurization of the at least one pressure vessel, and
wherein the pneumatic conveying unit is part of a mobile platform.

14. The system according to claim 13, further comprising at least one solid control device to receive drill cuttings before these cuttings are sent to the pneumatic conveying unit.

15. The system according to claim 13, wherein the at least one dumpster is part of a mobile platform.

16. The system according to claim 13, further comprising at least one receiver to convey the drill cuttings to the at least one dumpster.

17. The system according to claim 16, wherein the at least one receiver is part of a discharge unit, said discharge unit comprising:
at least one receiver,
at least one pipe, and
at least one outlet,
wherein the receiver is configured to direct the received drill cuttings to the at least one outlet via the at least one pipe, and wherein the discharge unit is part of a mobile platform.
